(19) United States
(12) Patent Application Publication
(10) Pub. No.: US 2018/0328397 A1
(43) Pub. Date: Nov. 15, 2018

(54) LATCH SYSTEM WITH QUICK CONNECTOR ASSEMBLY

(71) Applicant: Centrix Aero, LLC, Kent, WA (US)

(72) Inventor: Andres Hernandez, Kent, WA (US)

(21) Appl. No.: 15/972,023

(22) Filed: May 4, 2018

Related U.S. Application Data
(60) Provisional application No. 62/504,509, filed on May 10, 2017.

(51) Int. Cl. F16B 21/04; B64D 11/00; F16B 1/02

(52) U.S. Cl. CPC F16B 21/04; F16B 1/02; B64D 11/003

(57) ABSTRACT

A latch system is provided herein. The latch system includes a control rod, a control pin fixedly coupled to a first end of the control rod, and a quick connector assembly including a latch actuator connector coupled to a second end of the control rod, the latch actuator connector including a first flange fixedly attached to a shaft fixedly coupled to the control rod, a second flange slidably coupled to the control rod, a spring positioned between the first and second flanges, and a lock pin extending from the shaft, and a control rod connector including a connection slot mating with the lock pin when the latch actuator connector and the control rod connector are in an engaged configuration.

### CROSS REFERENCE TO RELATED APPLICATION

The present application claims priority to U.S. Provisional Application No. 62/504,509, entitled “Quick Lock Connector”, and filed on May 10, 2017. The entire contents of the above-listed application are hereby incorporated by reference for all purposes.

### TECHNICAL FIELD

This description relates generally to a latch system with a quick connector assembly.

### BACKGROUND

Connecting rods in mechanical latch assemblies, such as aircraft stowage bins, often require separate fastening hardware to fasten the rods to one or more attachment points. This typically necessitates additional hardware, additional operational steps when installing the connecting rod, etc. By adding more hardware to the mechanical assembly the complexity of the installation procedure is increased, thereby decreasing installation efficiency and driving up installation costs.

Connecting rods, for example, may be connected to latch components via counter locking threaded nuts interfacing with mating threaded rods at the connected members, threaded screws interfacing with threaded holes in each one of the connected members, or cotter pins extending through holes in the connected members. The aforementioned types of connection mechanisms require fastener tooling during installation forcing installation personnel to carry specialized tools. Additionally, these separate components can fail, be misplaced, etc. Moreover, if the installation environment is tight, the components may be lost or misplaced. Component loss or misplacement in an aerospace environment may lead to aircraft damage. These lost components are referred to in the aerospace industry as foreign object debris (FOD).

### SUMMARY

To resolve at least some of the abovementioned problems a latch system is provided. The latch system includes a control rod, a control pin fixedly coupled to a first end of the control rod, and a quick connector assembly including a latch actuator connector coupled to a second end of the control rod, the latch actuator connector including a first flange fixedly attached to a shaft fixedly coupled to the control rod, a second flange slidably coupled to the control rod, a spring positioned between the first and second flanges, and a lock pin extending from the shaft, and a control rod connector including a connection slot mating with the lock pin when the latch actuator connector and the control rod connector are in an engaged configuration. The latch system enables the control rod connector and the latch actuator connector to be intuitively and efficiently attached. As a result, the installation efficiency of the latch system may be increased. It will be appreciated that the attachment between the control rod connector and the latch actuator connector may be performed without tools and/or without calibration, if desired. Consequently, the latch system may be quickly installed, thereby reducing installation costs. Moreover, the latch system may be installed in confined environments, thereby increasing the system's applicability. Additionally, the likelihood of unintentionally losing or misplacing components in the system is reduced due to the efficient installation procedure. Consequently, the amount of foreign object debris (FOD) in the installation environment (e.g., aircraft) may be reduced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

Many of the attendant features will be more readily appreciated and become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an isometric drawing of a latch system including a quick connector assembly;

FIG. 2 is a side view of the latch system shown in FIG. 1;

FIG. 3 is an external view of the latch system with a control rod connector in the quick connector assembly removed;

FIG. 4 is another side view of the latch system, shown in FIG. 1;

FIG. 5 is a cross-section of the latch system, shown in FIG. 1;

FIG. 6 is a detailed view of the quick connector assembly in the latch system, shown in FIG. 5;

FIG. 7 is a detailed view of a control pin in the latch system, shown in FIG. 5; and

FIGS. 8-10 show a connection sequence in the quick connector assembly, shown in FIG. 5.

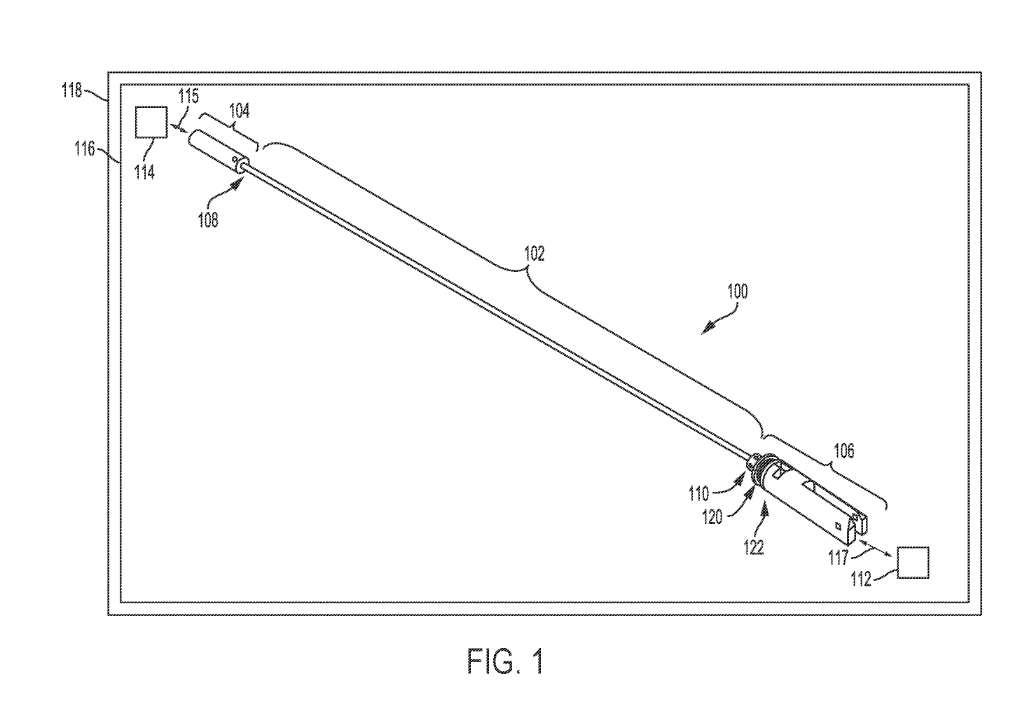

FIGS. 1-10 are drawn to scale. However, other relative dimensions may be used in other embodiments.

### DETAILED DESCRIPTION

A latch system with a quick connector assembly is described herein that allows for quick and efficient installation. The latch system design may also reduce the likelihood of lost or misplaced components during installation. The quick connector assembly may include a latch actuator connector designed to be releasably coupled to a control rod connector. The releasable coupling may take place through the mating between a lock pin in the latch actuator connector and a connection slot in the control rod connector. The connection slot includes an axially aligned portion and a radially aligned portion. During coupling between the latch actuator connector and the control rod connector the lock pin slides deeper into the axially aligned portion of the connection slot and then the lock pin is rotated to move the pin further into the radially aligned portion of the connection slot. In this way, the quick connector assembly may be efficiently connected, without the use of tools, if desired. The quick connector assembly may further include a spring-loaded flange with an extension designed to mate with the axially aligned portion of the connection slot when the quick connector assembly is in an engaged configuration. The extension provides another degree of connection assembly closure confidence. As a result, the likelihood of unwanted quick connector decoupling is reduced.

The examples below describe a latch system. Although the present examples are described and illustrated herein as being implemented in an aircraft and specifically an aircraft stowage bin, the system described is provided as an example and not a limitation. As those skilled in the art will appreciate, the present examples are suitable for application in a broad range of latch systems such as systems in the automotive industry, the construction industry, the maritime industry, etc.

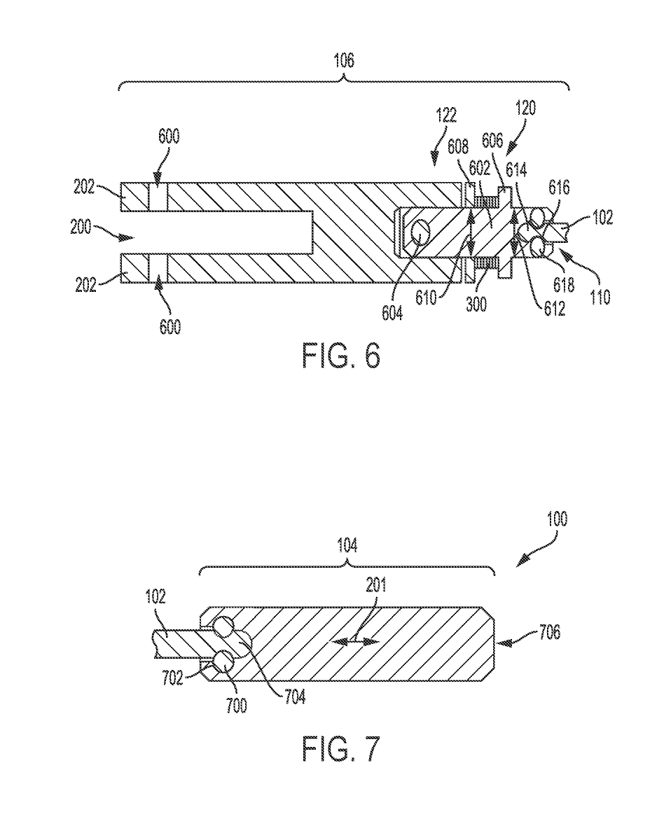

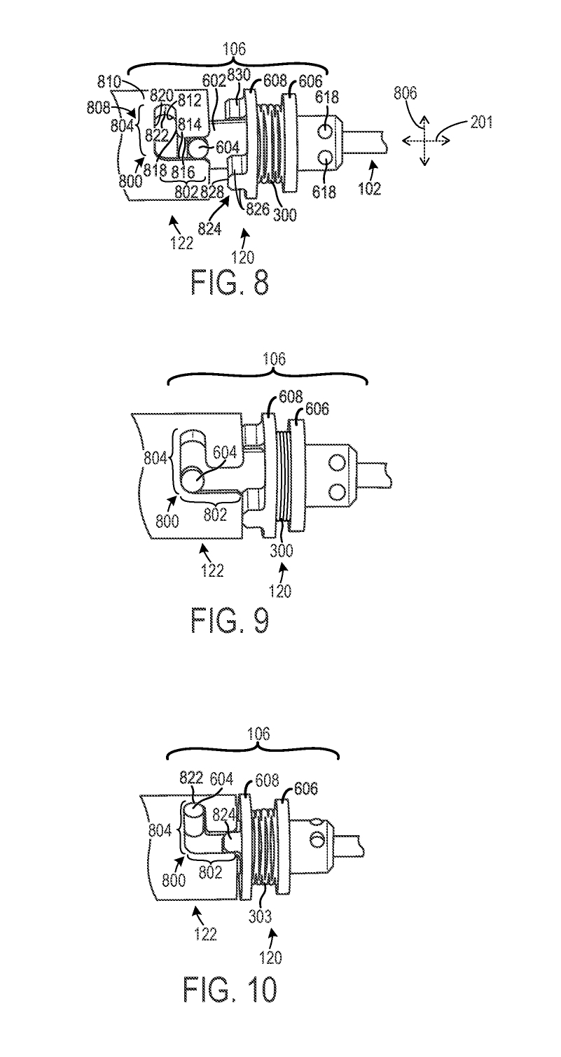

FIGS. 1-4 show different views of the latch system. FIG. 5 shows the latch system in cross-section. FIG. 6 shows a detailed view of the control rod connector and FIG. 7 shows a detailed view of the latch actuator connector in the latch system. FIGS. 8-10 show a connection sequence for the quick connector assembly in the latch system.

FIG. 1 shows a latch system 100 including a control rod 102, a control pin 104, and a quick connector assembly 106. However, in other examples, the control rod 102 and/or the control rod 102 may be omitted from the latch system 100. Therefore, in one example, the latch system 100 may include the control pin 104 and the quick connector assembly 106. In another example, the latch system 100 may include solely the quick connector assembly 106. The control pin 104 is coupled to a first end 108 of the control rod 102 and the quick connector assembly 106 is coupled to a second end 110 of the control rod 102. The control rod 102 has a constant diameter along its length, in the illustrated example. However, in other examples, the diameter of the control rod may vary along its length. The diameter of the control rod 102 may be selected to achieve desired rod structural integrity, flexibility, and/or profile. The control rod 102 may allow axial motion to be transferred from a latch actuator 112 to a latch unit 114. Arrow 115 indicates the axially actuation movement of the control pin 104 with regard to the latch unit 114. Arrow 117 indicates the axial motion transferred between the latch actuator 112 and the quick connector assembly 106.

Although the latch actuator 112 and the latch unit 114 are schematically depicted, it will be appreciated that the latch actuator and unit may have greater structural complexity that allows them to carry out the functions described herein. For instance, the latch actuator may include a handle designed to be rotationally actuated and/or the latch unit may include mechanical components designed to interact with the control pin to latch and unlatch the latch unit. Therefore, the latch unit 114 may be moved into a latched and an unlatched configuration. In the illustrated example, the latch system 100 is included in a stowage bin 116 in an aircraft 118. Therefore, the latch unit 114 may latch/unlatch the stowage bin 116 to allow/inhibit the user from accessing contents (e.g., baggage, equipment, etc.,) enclosed within an interior cavity of the stowage bin. However, as previously discussed the latch system 100 may be included in other operating environments including but not limited to land vehicles (e.g., cars, trucks, trains, etc.,), buildings, ships, or other environments where quick and efficient latch system installation/removal is desired.

In one example, axial movement of the control pin 104 may trigger engagement/disengagement with the latch unit 114 (e.g., remote latch unit). It will be appreciated that the latch actuator 112 may transfer the axial movement to the control pin 104 through the quick connector assembly 106 and the control rod 102. Axially latch unit actuation may allow for more robust and efficient actuation of the latch unit when compared to rotational unit actuation. However, in other examples, the control pin 104 and associated components may be designed to rotationally actuate the latch unit 114.

The control rod 102 has a cylindrical shape, in the illustrated example. However, other control rod shapes have been contemplated, such as rectangular, oval, or square cross-sectional profiles. The control rod shape may be selected based on the desired structural properties of the rod as well as the installation environment.

The quick connector assembly 106 includes a latch actuator connector 120 and a control rod connector 122. The latch actuator connector 120 is designed to attach to a latch actuator 112, in one example. The latch actuator 112 may include a handle or other suitable interface allowing for user actuation. The latch actuator 112 may, in one example, transform rotational actuation input into axial movement of the latch actuator connector. In this way, the latch actuator connector and therefore control rod may be moved in opposing axial directions responsive to actuation of the latch actuator. It will be appreciated that in other examples, the latch actuator 112 may be actuated via a non-rotational input. For instance, the latch actuator 112 may be slid inward and outward with regard to an actuator housing. In another example, the latch actuator 112 may exhibit both rotational and sliding movement during actuator.

The control pin 104 has a greater diameter than the control rod 102, in the depicted example. Additionally, the quick connector assembly 106 has a greater diameter than the control rod 102, in the illustrated example. Sizing the control rod, quick connector assembly, and the control pin in this manner may allow the latch system to be installed in tight environments with limited space. However, other relative sizes of the control rod, quick connector assembly, and/or the control pin have been contemplated. For instance, the control pin and/or the quick connector assembly may have a smaller diameter than the control rod.

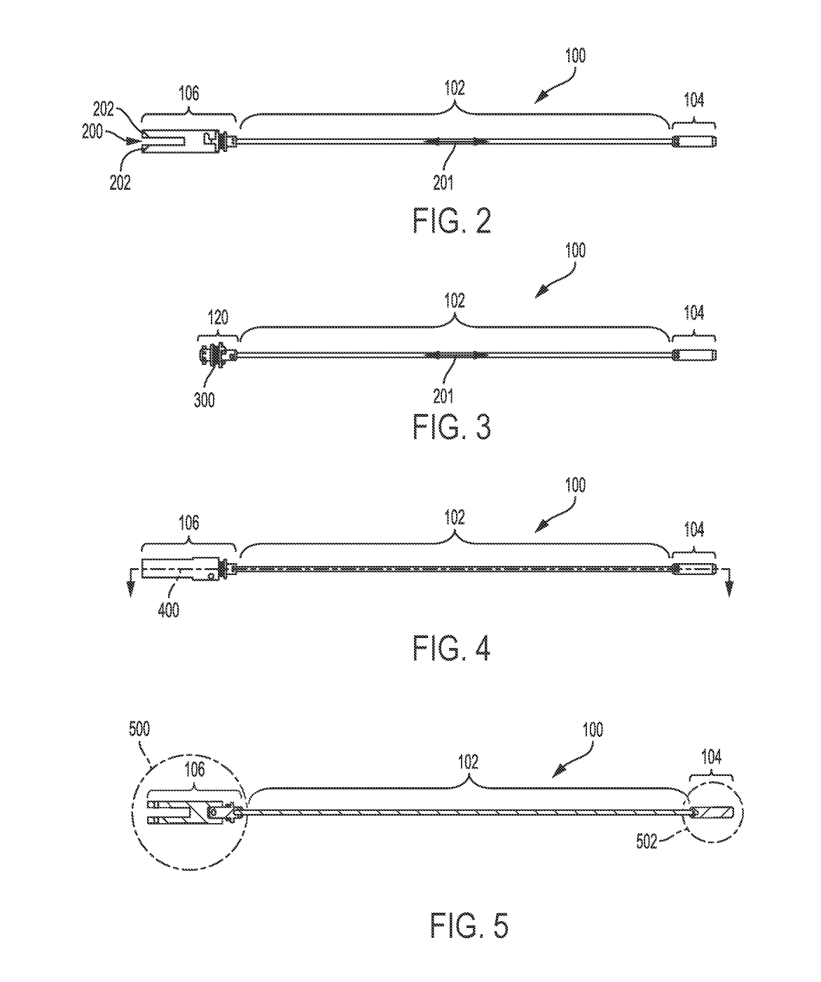

FIG. 2 shows a side view of the latch system 100 including the control rod 102, control pin 104, and the quick connector assembly 106. The aforementioned components share a common axis 201 (e.g., central axis) in the illustrated example. The latch actuator connector 120 includes a slot 200 positioned between two arms 202. The slot 200 may be contoured to mate with an extension in the latch actuator 112, shown in FIG. 1. However, other suitable attachment interface profiles in the latch actuator connector 120 have been contemplated.

FIG. 3 shows the latch system 100 with the control rod connector 122, shown in FIGS. 1 and 2 removed, to reveal underlying components in the quick connector assembly 106. To elaborate, the latch actuator connector 120 is illustrated. The latch actuator connector 120 is shown including a spring 300 positioned between two flanges. The latch actuator connector 120 is described in greater detail herein with regard to FIG. 6 and FIGS. 8-10. FIG. 3 also shows the axis 201 for reference.

FIG. 4 shows another side view of the latch system 100, shown in FIG. 1. The control rod 102, control pin 104, and the quick connector assembly 106 are again illustrated. FIG. 4 provides a cutting plane 400 defining the cross-sectional view shown in FIG. 5 for reference.

FIG. 5 shows a cross-sectional view of the latch system 100. Again, the control rod 102, control pin 104, and the quick connector assembly 106 are illustrated. Area 500 denotes the detailed view shown in FIG. 6 and area 502 denotes the detailed view shown in FIG. 7.

FIG. 6 shows a detailed view of the quick connector assembly 106 including the control rod connector 122 and the latch actuator connector 120. The slot 200 and arms 202 in the control rod connector 122 are again shown. Openings 600 extend (e.g., radially extend) through the arms 202. The openings 600 may receive a fastener such as a pin, screw, etc. Thus, the fastener may extend through the openings 600 when the latch actuator connector 120 is coupled to the latch actuator 112, shown in FIG. 1. It will be appreciated that the fastener may be inserted and secured in the openings without the use of tools, in one example, if desired. In this way, the quick connector assembly 106 may be swiftly attached to the latch actuator.

The latch actuator connector 120 is shown including a shaft 602 and a lock pin 604 extending (e.g., radially extending) therefrom. In one example, the latch actuator connector 120 may include a second lock pin positioned on an opposing side of the shaft 602. An interior flange 606 is also shown radially extending from the shaft 602. The shaft 602 and the interior flange 606 form a component having a continuous contour, in the illustrated example. However, it will be appreciated that the interior flange 606 and the shaft 602 may be separate components attached (e.g., fixedly attached) to one another, in other examples. For instance, the shaft 602 and the interior flange 606 may be welded, adhesively bonded, press fit, etc., to one another.

The latch actuator connector 120 includes a slidable flange 608 slidably coupled with the shaft 602. Thus, the slidable flange 608 may have an inner diameter 610 that is larger than the outer diameter 612 of the shaft 602. It will be appreciated that the variance in diameters may be selected to allow the slidable flange 608 to slide along the shaft 602 with limited misalignment between the interior surface of the slidable flange 608 and the exterior surface of the shaft 602. It will be appreciated that misalignment may be characterized by the interior and exterior surface falling out of a parallel arrangement. In one example, it will be appreciated that the variance in diameters may be 1.0 mm, 0.1 mm, or 0.001 mm, for example. It will also be appreciated that the interior flange 606 may be referred to as a first flange and the slidable flange 608 may be referred to as a second flange.

The latch actuator connector 120 also includes the spring 300 positioned between (e.g., axially between) the interior flange 606 and the slidable flange 608. The spring 300 is depicted as a coil spring in FIG. 6. However, other suitable types of springs have been contemplated, such as an elastomeric spring, a washer spring, etc. In these examples, the spring may have an annular shape, for instance. The spring 300 may exert a return force (e.g., axially outward force) on the slidable flange 608 when the slidable flange is moved inward toward the interior flange 606. Radially aligned surfaces in both the interior flange 606 and the slidable flange 608 may be in contact with the spring 300. The radially aligned surfaces may therefore be parallel to one other. However, other contours of the surfaces contacting the spring have been contemplated. For instance, the flanges may include notches that are designed to receive ends of the spring 300. The spring 300 also circumferentially surrounds the shaft 602. However, in other examples, the spring 300 may not circumferentially surround the shaft 602.

The slidable flange 608 has a greater outer diameter than the outer diameter of the interior flange 606. In this way, the slidable flange 608 may be easily actuated by installation personnel. However, in other examples, the flanges may have equivalent diameters or the slidable flange may have a smaller outer diameter than the outer diameter of the interior flange. The slidable flange 608 may also be contour to be easily gripped, in some examples. For instance, the slidable flange 608 may have indents, a textured surface, etc., to allow the flange to be easily manipulated by a user's hands.

The latch actuator connector 120 includes a rod opening 614 mated with the second end 110 of the control rod 102. The latch actuator connector 120 includes pin openings 616 having pins 618 extending there through. The pins 618 may therefore mate with the pin openings 616 in the shaft 602. In this way, the latch actuator connector 120 may be coupled to the control rod 102. However, other suitable connection techniques may be used such as welding, press fitting, clamping, etc.

FIG. 7 shows a detailed view of the control pin 104 in the latch system 100. The control pin 104 is shown coupled to the control rod 102 via pins 700 that mate with the control rod 102 and specifically with pin openings 702 adjacent to the head 704. However, additional or alternative connection mechanisms, techniques, etc., have been contemplated, such as clamps, screws, press fitting, welding, etc. Additionally, the control pin 104 includes an end 706 that tapers in an axial direction to enable smooth latch unit locking and unlocking. However, the control pin may have other contours, in other examples. The central axis 201 of the control rod 102 is illustrated in FIG. 7.

FIGS. 8-10 illustrate a connection sequence in the quick connector assembly 106 between the latch actuator connector 120 and the control rod connector 122. Specifically, FIG. 8 shows the control rod connector 122 with a connection slot 800 having an axially aligned section 802 and a radially aligned section 804. Thus, the axially aligned section 802 may be arranged perpendicular to the radially aligned section 804 forming an “L” type shape. FIG. 8 shows the control rod connector 122 coupled (e.g. fixedly coupled) to the control rod 102 of the control rod 102 via the pins 618, in the depicted example. However, other suitable attachment techniques may be used such as clamping, press fitting, welding, etc. The central axis 201 of the control rod 102 is provided for reference along with a radially aligned axis 806. The connection slot 800 radially extends through a housing 808 of the control rod connector 122. The housing 808 has an outer surface 810 and an inner surface 812 defining a boundary of an interior cavity that may be sized to receive the shaft 602.

The axially aligned section 802 includes a first side 814 and a second side 816. In the illustrated example, the first side 814 is parallel to the second side 816. In this way, the axially aligned section 802 may have a substantially constant width at least partially along its length. However, other contours of the axially aligned section have been contemplated. For example, the axially aligned section 802 may taper inward toward the central axis and/or may taper in a direction extending away from latch actuator connector 120.

The radially aligned section 804 also includes a first wall 818 and a second wall 820. Again, the first and second walls, 818 and 820, respectively, are parallel to one another, in the illustrated example. However, in other examples, the first wall 818 and the second wall 820 may not be parallel. For instance, the walls may taper in a direction extending inward toward the central axis and or taper in a circumferential direction. The radially aligned section 804 also includes an end wall 822. The end wall 822 may be curved such that is mates with the lock pin 604. However, other end wall contours may be used, in other examples, such as flat contours.

The latch actuator connector 120 includes the lock pin 604 that radially extends from the shaft 602. The lock pin 604 has a cylindrical shape, in the depicted example. However, it will be appreciated that other lock pin contours have been contemplated such as shapes with a rounded (e.g., semi-spherical) end.

The latch actuator connector 120 also includes an extension 824 extending (e.g., axially extending) from the interior flange 606. Additionally, the spring 300 is coupled to the slidable flange 608 and interior flange 606. Thus, the spring 300 is positioned axially between the slidable flange 608 and the interior flange 606. The interior flange 606 may be fixedly coupled to the shaft 602 while the slidable flange 608 may be designed to move in opposing axial directions with regard to the shaft 602, as previously discussed. In FIG. 8 the spring 300 is uncompressed. Furthermore, in FIG. 8 the lock pin 604 extends into the axially aligned section 802 of the connection slot 800. It will be appreciated that installation personnel may grasp the latch actuator connector 120 and the control rod connector 122 and slide the lock pin 604 into the axially aligned section 802. In this way, the installation personnel may initiate connection between the latch actuator connector 120 and the control rod connector 122 in the quick connector assembly 106.

The extension 824 includes two axially aligned sides 826 and a radially aligned side 828. The axially aligned sides may be in face sharing contact with the walls of the axially aligned section 802 of the connection slot 800 when the extension is mated therein. However, in other examples, there may be a slight gap between the axially aligned sides 826 of the extension 824 and the axially aligned section 802. Additionally, the radially aligned side 828 may be curved to allow for smooth mating with the connection slot 800. However, in other examples, the radially aligned side 828 may have a planar profile.

The extension 824 is shown offset (e.g. circumferentially offset) from the lock pin 604 extending (e.g., radially extending) from the shaft 602. Arranging the extension 824 and the lock pin 604 in this manner allows the extension to mate with the connection slot 800 when the lock pin 604 is rotated into the radially aligned section 804 of the connection slot 800. FIG. 8 also shows a second extension 830 that may be designed to mate with another connection slot position on an opposing side of the shaft 602. In such an example, a second lock pin may be mated with the second connection slot when the assembly is in the engaged configuration. It will be appreciated that the second connection slot and/or the second lock pin may have a similar size and profile to the lock pin 604 and the connection slot 800. The second extension 830 may also be included in and protrude from the slidable flange 608. It will be appreciated that the second extension 830 may be mated with an axially aligned slot in the second connection slot. In such an example, a second lock pin may also extend from the shaft 602 and may be configured to mate with the second connection slot. In this way, symmetric connection points may be provided on both sides of the quick connector assembly 106, thereby balancing load transfer through the quick connector assembly 106. However, it will be appreciated that in other examples, the quick connector assembly 106 may include a single connection slot and a lock pin or three or more slots and lock pins that may or may not be equally spaced with regard to a circumference of the shaft.

FIG. 9 shows the lock pin 604 further inserted into the axially aligned section 802 of the connection slot 800. In this way, the lock pin 604 travels through the length of the axially aligned section during engagement of the quick connector assembly 106. Specifically, the lock pin 604 may be moved to the intersection between the axially aligned section 802 and the radially aligned section 804 of the connection slot 800. As previously discussed, installation personnel may quickly and efficiently carry out this movement. Furthermore, it will be appreciated that compression of the spring 300 enables movement of the lock pin 604 further into the connection slot 800.

FIG. 10 shows the lock pin 604 further guided into the radially aligned section 804 of the connection slot 800. It will be appreciated that rotation of the latch actuator connector 120 relative to the control rod connector 122 or vice versa may allow the lock pin 604 to be move further into the radially aligned section of the connection slot and mate there within. Specifically, in the illustrated example, the lock pin 604 is adjacent to (e.g., in face sharing contact with) the end wall 822. In this way, further rotation between the control rod connector 122 and the latch actuator connector 120 may be inhibited by the end wall 822. It will be appreciated that the circumferential length of the radially aligned section 804 may correspond to a radial offset between the lock pin 604 and the extension 824. In this way, alignment between the extension 824 and the axially aligned section 802 of the connection slot may be achieved when the lock pin 604 reaches the end of the axially aligned section in an engaged (e.g., fully engaged) configuration. In this way, the engaged configuration where the lock pin 604 is mated with the radially aligned section 804 of the connection slot 800 and the extension 824 is mated with the axially aligned section 802 of the connection slot 800 can be intuitively achieved. Consequently, desired connection operation between the latch actuator connector 120 and the control rod connector 122 can be efficiently carried out.

Additionally, in FIG. 10 the extension 824 is shown inserted into the axially aligned section of the connection slot 800. In this way, rotational movement between the control rod connector 122 and the latch actuator connector 120 is substantially inhibited. In the illustrated example, the spring 300 may be in a neutral state. In such an example, the spring 300 may exert a return force on the slidable flange 608 when the flange is moved away from the connection slot 800. However, in other examples, the spring 300 shown in FIG. 10 may be slightly compressed such that it exerts a force on the slidable flange 608 to enable the flange to be retained in the engaged position. The interior flange 606 is also shown in FIG. 10 allowing the spring 300 to be axially contained.

It will be appreciated that during an engagement sequence the lock pin 604 may be first axially moved through the connection slot 800 and then rotated to place the lock pin 604 in contact or near contact with the end wall 822 to place the quick connector assembly 106 in an engaged configuration. Additionally, the extension 824 may be mated with the axially aligned section 802 of the connection slot 800 when the quick connector assembly is in the engaged configuration. To disengage the quick connector assembly 106 it will be appreciated that the aforementioned sequence may be reversed. For example, the slidable flange 608 may be slid toward the interior flange 606 such that the spring is compressed and the extension is unmated from the axially aligned section of the connection slot 800. Subsequent to decoupling of the extension from the connection slot, the lock pin 604 may be rotated such that is travels through the radially aligned section of the connection slot and then is subsequently axially moved through the axially aligned slot.

It will be appreciated that FIG. 10 shows in the quick connector assembly 106 in an engaged configuration where the control rod connector 122 is coupled to the latch actuator connector 120. On the other hand, in the disengaged configuration the lock pin 604 may be in any position where it is not mated with the radially aligned section of the connection slot. For instance, the positions shown in FIGS. 8 and 9 may be a disengaged configuration or in one example may be characterized as a partially disengaged configuration. A fully disengaged configuration may be characterized as a configuration where the lock pin 604 is spaced away from the connection slot 800. In this way, the quick connector assembly may be efficiently configured in an engaged and disengaged state, thereby increasing installation efficiency and driving down installation costs.

FIGS. 1-10 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The invention will further be described in the following paragraphs. In one aspect, a latch system is provided that includes a control rod, a control pin fixedly coupled to a first end of the control rod, and a quick connector assembly including, a latch actuator connector coupled to a second end of the control rod, the latch actuator connector including a first flange fixedly attached to a shaft fixedly coupled to the control rod, a second flange slidably coupled to the control rod, a spring positioned between the first and second flanges, and a lock pin extending from the shaft, and a control rod connector including a connection slot mating with the lock pin when the latch actuator connector and the control rod connector are in an engaged configuration.

In another aspect, a latch system is provided that includes a control rod, a control pin fixedly coupled to a first end of the control rod, and a quick connector assembly including, a latch actuator connector coupled to a second end of the control rod, the latch actuator connector including a first flange fixedly attached to a shaft fixedly coupled to the control rod, a second flange slidably coupled to the control rod, a spring positioned between the first and second flanges, and a lock pin extending from the shaft, and a control rod connector including a connection slot including an axially aligned section and a radially aligned section mating with the lock pin when the latch actuator connector and the control rod connector are in an engaged configuration.

In another aspect, a latch system in an aircraft stowage bin, the latch system including a control rod, a control pin fixedly coupled to a first end of the control rod, a quick connector assembly including a latch actuator connector coupled to a second end of the control rod, the latch actuator connector including a first flange fixedly attached to a shaft fixedly coupled to the control rod, a second flange slidably coupled to the control rod, a spring positioned between the first and second flanges, and a lock pin extending from the shaft, and a control rod connector including a connection slot mating with the lock pin when the latch actuator connector and the control rod connector are in an engaged configuration, a latch unit receiving an axial input from the control pin, and a latch actuator coupled to a housing of the aircraft stowage bin and to the control rod connector and axially actuating the control rod connector.

In any of the aspects or combinations of the aspects, the connection slot may include an axially aligned section and a radially aligned section.

In any of the aspects or combinations of the aspects, the axially aligned section may extend to an end of the control rod connector.

In any of the aspects or combinations of the aspects, when the control rod connector is transitioned from an unengaged configuration to the engaged configuration the lock pin may travel through the axially aligned section and into the radially aligned section.

In any of the aspects or combinations of the aspects, the latch system may further include an extension axially extending from the second flange and mating with the connection slot when the latch actuator connector and the control rod connector are in the engaged configuration.

In any of the aspects or combinations of the aspects, the extension may be radially offset from the lock pin.

In any of the aspects or combinations of the aspects, the latch system may further include a latch actuator coupled to the control rod connector and axially actuating the control rod connector.

In any of the aspects or combinations of the aspects, in the engaged configuration the spring may be in a neutral position.

In any of the aspects or combinations of the aspects, the spring may circumferentially surround the shaft.

In any of the aspects or combinations of the aspects, when the control rod connector is transitioned from an unengaged configuration to the engaged configuration the lock pin may travel through the axially aligned section and into the radially aligned section.

In any of the aspects or combinations of the aspects, the latch system may further include a latch unit receiving an axial input from the control pin and a latch actuator coupled to the control rod connector and axially actuating the control rod connector.

In any of the aspects or combinations of the aspects, in the engaged configuration the spring may be in a neutral position and when the lock pin is positioned within the axially aligned section the spring is compressed.

In any of the aspects or combinations of the aspects, the latch system may further include an extension axially extending from the second flange and mating with the connection slot when the latch actuator connector and the control rod connector are in the engaged configuration and where the extension is radially offset from the lock pin.

In any of the aspects or combinations of the aspects, the spring may circumferentially surround the shaft.

In any of the aspects or combinations of the aspects, when the control rod connector is transitioned from an unengaged configuration to the engaged configuration the lock pin may travel through the axially aligned section and into the radially aligned section.

In any of the aspects or combinations of the aspects, in the engaged configuration the spring may be in a neutral position and when the lock pin is positioned within the axially aligned section the spring is compressed.

In any of the aspects or combinations of the aspects, the latch system may further include an extension axially extending from the second flange and mating with the connection slot when the latch actuator connector and the control rod connector are in the engaged configuration and where the extension is radially offset from the lock pin.

Note that the example control and estimation routines included herein can be used with various latch system configurations. The control methods and routines disclosed herein may be stored as executable instructions in non-transitory memory and may be carried out by tooling apparatuses.

The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the latch system, where the described actions are carried out by executing the instructions in a tooling apparatus and latch system including the various components.

It will be appreciated that the configurations and routines disclosed herein are exemplary in nature, and that these specific embodiments are not to be considered in a limiting sense, because numerous variations are possible. For example, the above technology can be applied to a broad range of manufacturing fields such as the aerospace industry, the construction industry, the maritime industry, etc. The subject matter of the present disclosure includes all novel and non-obvious combinations and sub-combinations of the various systems and configurations, and other features, functions, and/or properties disclosed herein.

The detailed description provided herein in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

Those skilled in the art will realize that the process sequences described above may be equivalently performed in any order to achieve a desired result. Also, sub-processes may typically be omitted as desired without taking away from the overall functionality of the processes described above.

1. A latch system, comprising:
a control rod;
a control pin fixedly coupled to a first end of the control rod; and
a quick connector assembly including;
a latch actuator connector coupled to a second end of the control rod, the latch actuator connector including a first flange fixedly attached to a shaft fixedly coupled to the control rod, a second flange slidably coupled to the control rod, a spring positioned between the first and second flanges, and a lock pin extending from the shaft; and
a control rod connector including a connection slot mating with the lock pin when the latch actuator connector and the control rod connector are in an engaged configuration.

2. The latch system of claim 1, where the connection slot includes an axially aligned section and a radially aligned section.

3. The latch system of claim 2, where the axially aligned section extends to an end of the control rod connector.

4. The latch system of claim 2, where when the control rod connector is transitioned from an unengaged configuration to the engaged configuration the lock pin travels through the axially aligned section and into the radially aligned section.

5. The latch system of claim 1, further comprising an extension axially extending from the second flange and mating with the connection slot when the latch actuator connector and the control rod connector are in the engaged configuration.

6. The latch system of claim 5, where the extension is radially offset from the lock pin.

7. The latch system of claim 1, further comprising a latch unit receiving an axial input from the control pin.

8. The latch system of claim 1, further comprising a latch actuator coupled to the control rod connector and axially actuating the control rod connector.

9. The latch system of claim 1, where in the engaged configuration the spring is in a neutral position.

10. The latch system of claim 1, where the spring circumferentially surrounds the shaft.

11. A latch system, comprising:
a control rod;
a control pin fixedly coupled to a first end of the control rod; and
a quick connector assembly including;
a latch actuator connector coupled to a second end of the control rod, the latch actuator connector including a first flange fixedly attached to a shaft fixedly coupled to the control rod, a second flange slidably coupled to the control rod, a spring positioned between the first and second flanges, and a lock pin extending from the shaft; and
a control rod connector including a connection slot including an axially aligned section and a radially aligned section mating with the lock pin when the latch actuator connector and the control rod connector are in an engaged configuration.

12. The latch system of claim 11, where when the control rod connector is transitioned from an unengaged configuration to the engaged configuration the lock pin travels through the axially aligned section and into the radially aligned section.

13. The latch system of claim 11, further comprising;
a latch unit receiving an axial input from the control pin; and
a latch actuator coupled to the control rod connector and axially actuating the control rod connector.

14. The latch system of claim 11, where in the engaged configuration the spring is in a neutral position and when the lock pin is positioned within the axially aligned section the spring is compressed.

15. The latch system of claim 11, further comprising an extension axially extending from the second flange and mating with the connection slot when the latch actuator connector and the control rod connector are in the engaged configuration and where the extension is radially offset from the lock pin.

16. The latch system of claim 11, where the spring circumferentially surrounds the shaft.

17. A latch system in an aircraft stowage bin, the latch system comprising:
a control rod;
a control pin fixedly coupled to a first end of the control rod;
a quick connector assembly including;
a latch actuator connector coupled to a second end of the control rod, the latch actuator connector including a first flange fixedly attached to a shaft fixedly coupled to the control rod, a second flange slidably coupled to the control rod, a spring positioned between the first and second flanges, and a lock pin extending from the shaft; and
a control rod connector including a connection slot mating with the lock pin when the latch actuator connector and the control rod connector are in an engaged configuration;
a latch unit receiving an axial input from the control pin; and
a latch actuator coupled to a housing of the aircraft stowage bin and to the control rod connector and axially actuating the control rod connector.

18. The latch system of claim 17, where when the control rod connector is transitioned from an unengaged configuration to the engaged configuration the lock pin travels through the axially aligned section and into the radially aligned section.

19. The latch system of claim 17, where in the engaged configuration the spring is in a neutral position and when the lock pin is positioned within the axially aligned section the spring is compressed.

20. The latch system of claim 17, further comprising an extension axially extending from the second flange and mating with the connection slot when the latch actuator connector and the control rod connector are in the engaged configuration and where the extension is radially offset from the lock pin.
